(19) United States
(12) Patent Application Publication
(10) Pub. No.: US 2007/0025790 A1
(43) Pub. Date: Feb. 1, 2007

(54) Ribbon Cassette Capable of Maintaining Ribbon Position

(76) Inventor: Yueh-Cheng Lin, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,532

(22) Filed: Sep. 14, 2005

(30) Foreign Application Priority Data
Aug. 1, 2005 (TW) 094126043

(51) Int. Cl. B41J 35/04; B41J 35/28; B65H 75/14

(52) U.S. Cl. 400/208; 400/242; 400/248

(57) ABSTRACT

A ribbon cassette capable of maintaining ribbon position includes a shell, two spools, and two guides. The two spools are each rotatably disposed above the shell for transporting the ribbon. The two guides are each disposed at one side of one of the two spools for maintaining the position of the ribbon. The ribbon cassette of the present invention is capable of avoiding shift of the ribbon on the spools in a transportation process of the thermal transfer printer or the ribbon cassette itself. Hence the problem of wrinkles due to such shift is reduced.

### BACKGROUND OF THE INVENTION

1. Field of the Invention

The present invention relates to a ribbon cassette, and more particularly, to a ribbon cassette capable of maintaining ribbon position.

2. Description of the Prior Art

In thermal transfer printers, a ribbon on the spools of a thermal transfer printer is easily shifted by bumping, gravity, or other factors. This means the ribbon can easily deviate from a default transportation direction inside a prior art ribbon cassette. When performing printing with ribbon whose position deviates in such a manner, wrinkles can be generated so that the quality of printing is significantly lowered. Furthermore, the ribbon and the shell of the prior art ribbon cassette easily contact and interfere with each other. The ribbon can therefore become jammed inside the shell of the prior art ribbon cassette.

FIG. 1 is a diagram of a prior art ribbon cassette 100 of a thermal transfer printer and a ribbon 101. The ribbon 101 is used for thermal transfer printing and is not tilted nor wrinkled by any external forces. The ribbon cassette 100 comprises a shell 103, a first spool 105, and a second spool 107. The first spool 105 is disposed on a supply end of the shell 103 in a rotatable manner. The second spool 107 is disposed on a recycling end of the shell 103. The end of the ribbon 101 is often attached to the second spool 107 by an adhesive tape 109 so that the ribbon 101 can be wrapped around the second spool 107.

FIG. 2 is a diagram of the prior art ribbon cassette 100 of the thermal transfer printer and the ribbon 101, wherein the position of the ribbon 101 on the first spool 105 is shifted by an external force so that wrinkles occur on an unspooled part 1011 of the ribbon 101. If the ribbon 101 is shifted and there is a wrinkle on the ribbon 101, the ribbon 101 will not be smooth while the ribbon 101 is transported between the first spool 105 and the second spool 107. Therefore, the quality of thermal transfer printing is decreased, and there may be some defects in the patterns printed by the ribbon 101.

FIG. 3 is a diagram of the prior art ribbon cassette 100 of the thermal transfer printer. Not only there are wrinkles on the unspooled part 1011 of the ribbon 101, but the ribbon 101 is further shifted by the rotation of the first spool 105 and the second spool 107. The ribbon 101 becoming shifted or the spool 105 jammed in the shell 103 is sometimes caused by the effect of the viscosity of the ink.

Since unpredictable phenomena between the spools and the ribbon of the prior art ribbon cassette of the thermal transfer printer are not prevented in advance, the aforementioned problems in the ribbon are caused and the quality of printing is decreased.

### SUMMARY OF THE INVENTION

Therefore the claimed invention provides a ribbon cassette capable of maintaining ribbon position to solve the aforementioned problems.

The claimed invention provides a ribbon cassette capable of maintaining ribbon position comprising a shell, a first spool disposed on the shell in a rotatable manner, a second spool disposed on the ribbon cassette in a rotatable manner. A ribbon is transported by the first spool and the second spool by rotation of the spools. Two guides, each disposed at one side of the first spool, are provided for fixing the position of the ribbon on the first spool.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a ribbon cassette of a prior art thermal transfer printer and a ribbon, wherein the ribbon is not shifted nor wrinkled by any external forces.

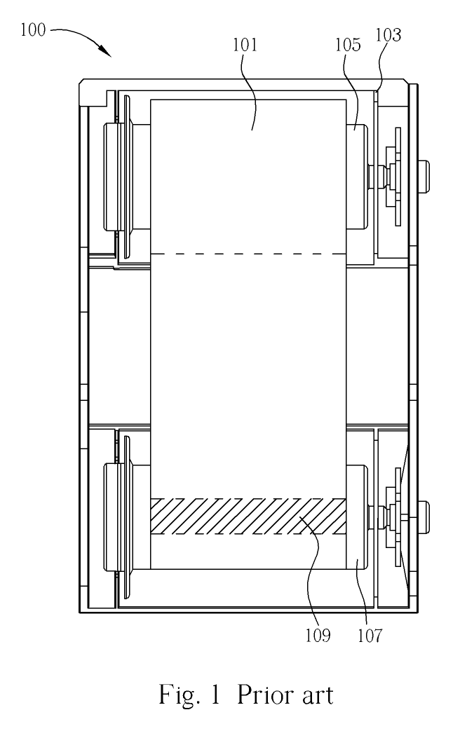

FIG. 2 is a diagram of the ribbon cassette of the prior art thermal transfer printer and the ribbon, wherein the position of the ribbon on the first spool is shifted by an external force so that wrinkles occur on an unspooled part of the ribbon.

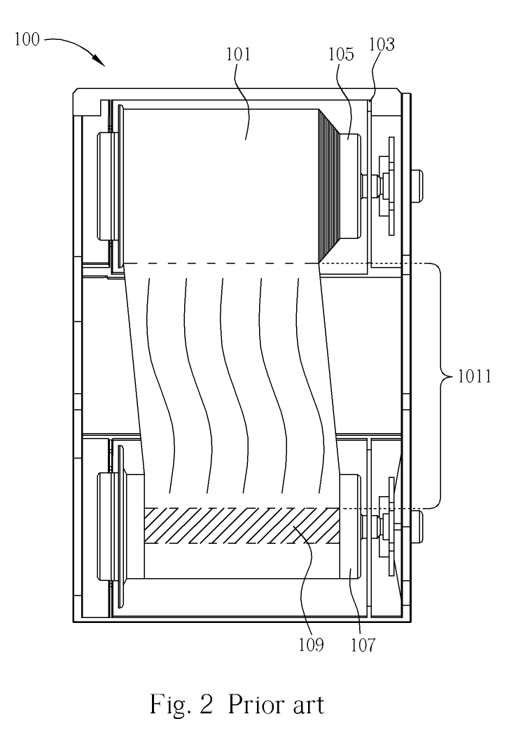

FIG. 3 is a diagram of the ribbon cassette of the prior art thermal transfer printer, wherein there are wrinkles on the unspooled part of the ribbon and the ribbon is further shifted by the rotational transportation between the first spool and the second spool.

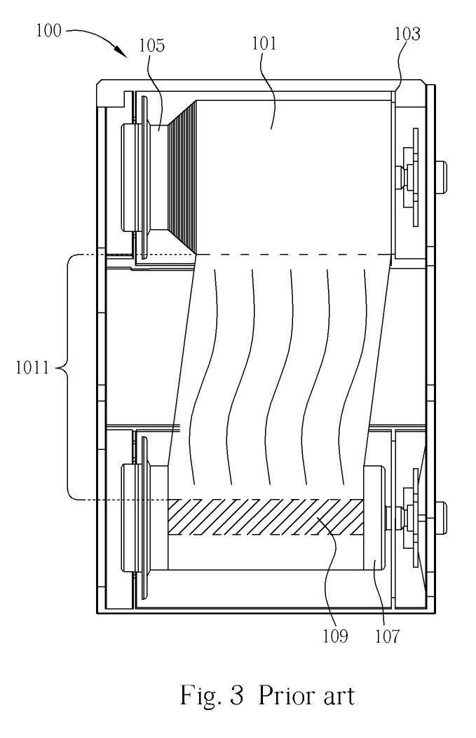

FIG. 4 is a diagram of a ribbon cassette of a thermal transfer printer in the present invention, wherein there are no wrinkles on an unfolded part of a ribbon.

FIG. 5 is a diagram of guides permanently disposed on the first spool in the ribbon cassette of FIG. 4.

FIG. 6 is an exploded view of guides disposed detachably on the first spool of the ribbon cassette of FIG. 4.

FIG. 7 is a perspective diagram of the guides disposed detachably on the first spool of the ribbon of FIG. 4.

### DETAILED DESCRIPTION

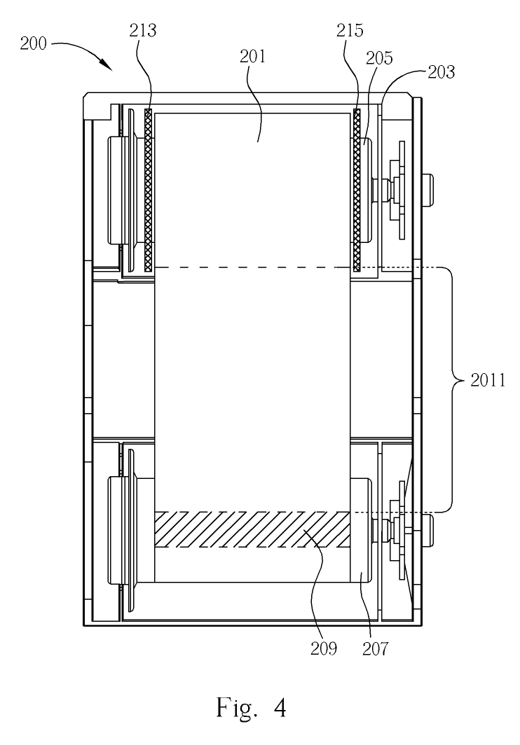

Please refer to FIG. 4, which is a diagram of a ribbon cassette 200 of a thermal transfer printer in the present invention, wherein there are no wrinkles on an unspooled part 2011 of the ribbon 201. The ribbon cassette 200 comprises a shell 203, a first spool 205, a second spool 207, a first guide 213, and a second guide 215. The first spool 205 and the second spool 207 are disposed on the shell 203 in a rotatable manner. The first guide 213 and the second guide 215 are each disposed at one side of the first spool 205. The first spool 205 and the second spool 207 are used for transporting the ribbon 201 by rotation of both the spools. In a preferred embodiment of the present invention, the ribbon 201 can be attached with an adhesive tape 209 for fixing the position of the ribbon 201 on the second spool 207 so that the ribbon 201, wrapped around the second spool 207, can be transported smoothly by the second spool 207.

The first guide 213 and the second guide 215 are disposed at where both the guides are in contact with the first spool 205. Therefore, the position of the ribbon 201 on the first spool 205 can be maintained in a fixed range on the first spool 205 so that an included angle between a spooling direction of the ribbon 201 and the direction of the transportation of the ribbon 201 is fixed, the spooling direction being from the first spool 205 to the second spool 207. Thus, the transportation direction of the ribbon 201 is not easily shifted. The unspooled part 2011 of the ribbon 201 is also not easily wrinkled nor jammed by the shell 203. Therefore the quality of the resulting printing is improved.

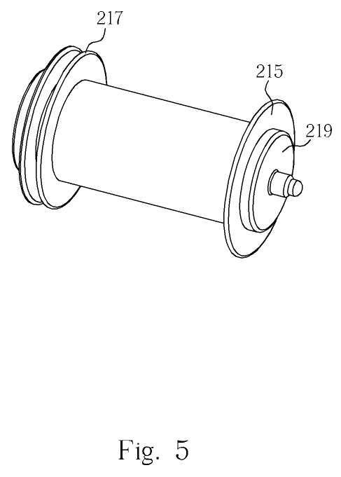

In the claimed ribbon cassette 200, both guides can be designed to be detachably or permanently disposed on the first spool 205 of the ribbon cassette 200. Please refer to FIG. 5, which is a diagram of the guides 217 and 219 permanently disposed on the first spool 205 of the ribbon cassette 200. In FIG. 5, both the guides 217 and 219 are permanently disposed on the first spool 205, and a tilt or shift of the ribbon 201 shown in FIG. 4 is restricted by a normal force and a friction force generated by both the permanently disposed guides 217 and 219. The direction of the transportation of the ribbon 201 from the supply end to the recycling end of the shell 203 is restricted by the normal force and the friction force generated by both the guides 217 and 219 as well as the degree of shift of the ribbon 201. Thus, the ribbon 201 can be printed, that is transported in a predictable direction, and prevented from being shifted or otherwise deviating from an expected shape.

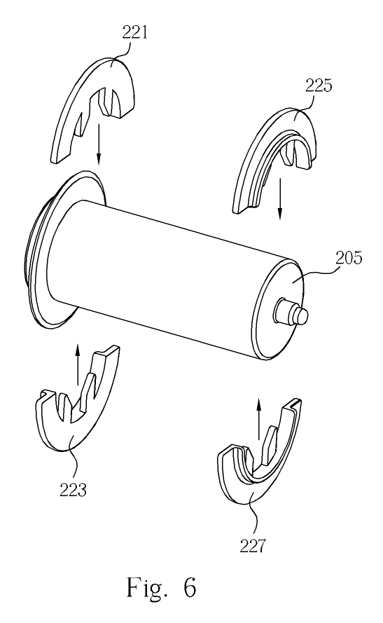

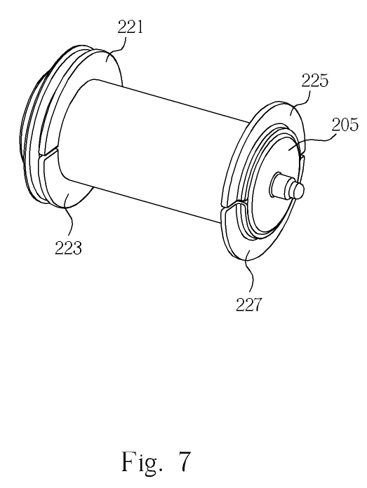

Please refer to FIG. 6 and FIG. 7. FIG. 6 is an exploded view of four guides 221, 223, 225, and 227 disposed detachably on the first spool 205 of the ribbon cassette 200. FIG. 7 is a perspective diagram of the four guides 221, 223, 225, and 227 disposed detachably on the first spool 205 of the ribbon cassette 200. As shown in FIG. 6 and FIG. 7, the guides 221 and 223 are disposed detachably at one side of the first spool 205 for restricting the ribbon 201 (not shown) from being shifted. Such restriction comes from a normal force and a friction force generated by both the guides 221 and 223. The guides 225 and 227 are disposed detachably on another side of the first spool 205 for restricting the ribbon 201 similarly.

For preventing the ribbon on the first spool of a ribbon cassette from becoming shifted or jammed by the shell 203, which can be caused by vibration, gravity, or inappropriate external force, two guides are each disposed detachably or permanently on one side of the first spool of the ribbon cassette of the present invention. Both the guides are each separated from the ribbon by an appropriate distance and are used for fixing the direction of transportation of the ribbon from the supply end to the recycling end of the shell by a normal force and a friction force and for restricting the degree of shift of the ribbon so that wrinkles and other defects of the prior art can be avoided. If the direction of the transportation of the ribbon is fixed, then there is less shift in the ribbon, and the quality of the resulting thermal transfer printing is improved. Moreover, the present invention ribbon cassette is capable of preventing shift generated by vibrations from use, from transport, or from another source.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A ribbon cassette capable of maintaining ribbon position, comprising:
a shell;
a first spool disposed on the shell in a rotatable manner;
a second spool disposed on the shell in a rotatable manner, wherein a ribbon is transported by the first spool and the second spool by rotation of the spools; and
two guides, each disposed at one side of the first spool for fixing the position of the ribbon on the first spool.

2. The ribbon cassette of claim 1, wherein the two guides are permanently disposed on the first spool.

3. The ribbon cassette of claim 1, wherein the two guides are detachably disposed on the first spool.

4. The ribbon cassette of claim 1, wherein the two guides are in contact with the ribbon.

5. The ribbon cassette of claim 1 being a ribbon cassette of a thermal transfer printer.

6. A thermal transfer printer capable of maintaining ribbon position, comprising:
a ribbon;
a thermal print head for heating ink on the ribbon; and
a ribbon cassette for holding the ribbon, the ribbon cassette comprising:
a shell;
a first spool disposed on the shell in a rotatable manner;
a second spool disposed on the shell in a rotatable manner, wherein the ribbon is transported by the first spool and the second spool by rotation of the spools; and
two guides, each disposed at one side of the first spool for fixing the position of the ribbon on the first spool.

7. The ribbon cassette of claim 6, wherein the two guides are permanently disposed on the first spool.

8. The ribbon cassette of claim 6, wherein the two guides are detachably disposed on the first spool.

9. The ribbon cassette of claim 1, wherein the two guides are in contact with the ribbon.
